(19) United States
(12) Patent Application Publication
(10) Pub. No.: US 2022/0157282 A1
(43) Pub. Date: May 19, 2022

(54) METHOD FOR ANALYZING MUSICAL COMPOSITIONS

(71) Applicant: Moodagent A/S, Copenhagen K (DK)

(72) Inventors: Søren DYRSTING, Copenhagen K (DK); Mikael HENDERSON, Copenhagen K (DK); Peter Berg STEFFENSEN, Copenhagen K (DK)

(73) Assignee: Moodagent A/S, Copenhagen K (DK)

(21) Appl. No.: 17/288,741

(22) PCT Filed: Oct. 24, 2019
(86) PCT No.: PCT/EP2019/079058

§ 371 Date: Apr. 26, 2021

(30) Foreign Application Priority Data
Oct. 26, 2018 (EP) 18202889.4

(51) Int. Cl. G10H 1/00

(52) U.S. Cl. CPC G10H 1/0008; G10H 2210/041; G10H 2250/115; G10H 2240/151; G10H 2210/061

(57) ABSTRACT

A method of determining on a computer-based system at least one representative segment of a musical composition, the method including providing a digital audio signal representing said musical composition; dividing said digital audio signal into a plurality of frames of equal frame duration; calculating at least one audio feature value for each frame by analyzing the digital audio signal, said audio feature being a numerical representation of a musical characteristic of said digital audio signal, with a numerical value equal to or higher than zero; identifying at least one representative frame corresponding to a maximum value of said audio feature; and determining at least one representative segment of the digital audio signal with a predefined segment duration, the starting point of said at least one representative segment being a representative frame.

### TECHNICAL FIELD

The disclosure relates to the field of digital sound processing, more particularly to a method and system for analyzing and automatically generating a short summary of a musical composition.

### BACKGROUND

As computer technology has improved, the digital media industry has evolved greatly in recent years. Electronic devices such as smartphones, tablets, or desktop computers, can be used to consume music, video and other forms of media content. At the same time, advances in network technology have increased the speed and reliability with which information can be transmitted over computer networks. It has therefore become technically possible for users to stream media content over these networks on demand, as well as to easily and quickly download entire files for consumption.

Online music providers exploit these possibilities by allowing users to browse large collections of musical compositions using their electronic devices, whereby users can select any musical composition to purchase or to listen to directly. However, since users are exposed to a huge amount of musical content within any such collection, they do not have the time to listen to all the compositions to decide which ones they would like to purchase or listen to, and therefore rely on recommendations from friends, from the media, or from the music providers directly.

Different music providers use different methods to recommend musical compositions from their collections to users. Most of these methods rely at least in part on analyzing the listening history of the users and recommending musical compositions based on similarities to compositions the user listened to before. To be able to determine similarities between the musical compositions, their digital audio signals are extracted and analyzed.

However, performing analysis on the full audio signal of hundreds of millions of musical compositions requires a large amount of time and huge amounts of computing power that needs to be deployed continuously to try to keep up with the exponential growth of these online music collections.

One possible way to reduce the computing power needed for the similarity analysis and thus making the process more scalable would be to only analyze a shorter, representative summary of a musical composition instead of its full-length audio signal. However, the prior art has not provided any satisfactory automated method for determining such a representative summary that could be used for similarity analysis.

On the other hand, due to copyright regulations, music providers also need to limit the access to particular compositions for users who have not purchased them yet or for any reason do not possess the full rights for streaming them to their devices. To comply with these regulations, short previews are generated for each music composition that users can listen to. These previews are often automatically extracted from the beginning of a musical composition, or by searching for the most repetitive parts of the musical composition. The previews are then stored on the servers of the music providers to be available for the users for streaming before purchasing full access.

However, these initial or most repetitive segments are often not representative of a musical composition as a whole and therefore the users often get inaccurate or irrelevant information about the musical compositions or no relevant information at all.

It is also known to have music compositions analyzed by persons that are trained to be able to determine the most representative segment or segments of a musical composition by listening to the musical composition as a whole, often several times in a row. However, this is a very time-consuming and cumbersome process that is not suitable for dealing with large collections of musical compositions, and the prior art has not provided any satisfactory method for automating this process that could be carried out by technical means such as a computer system.

Therefore, a need exists for a method that enables automatically and efficiently analyzing musical compositions to determine and extract the most representative segment(s) thereof, which segments can be stored as listener previews on a storage device (e.g. of a streaming server) and retrieved upon request for playback (e.g. by a client device), or can be used as accurate representations to determine similarities between musical compositions, and thereby ultimately enhancing searchability of a large music catalogue, thereby allowing a user to quickly determine if a musical composition is to his/her liking.

### SUMMARY

The aspects of the disclosed embodiments are directed to a method and system for determining, on a computer-based system, the most representative segment or segments of a musical composition and thereby solving or at least reducing the problems mentioned above. The method and system enhances searchability of a large music catalogue by enabling automatic and efficient processing of large and continuously growing music databases and providing relevant short representations for each musical composition in the database, and by further enabling accurate grouping of musical compositions in the database based on similarities of their representative segments. The method and system also enables saving storage space and computing resources by reducing the data size needed for musical analysis of the musical compositions. The method and system also solves the problem of replacing the original audio signals with accurate representations thereof, thereby enabling compliance with copyright regulations of music rights holders.

The foregoing and other aspects of the disclosed embodiments are achieved by the features of the independent claims. Further implementation forms are apparent from the dependent claims, the description and the figures.

According to a first aspect, there is provided a method of determining on a computer-based system at least one representative segment of a musical composition, the method comprising:

acquiring a digital audio signal representing the musical composition;

dividing the digital audio signal into a plurality of frames of equal frame duration L_{f};

calculating at least one audio feature value for each frame by calculating the Root Mean Squared (RMS) audio energy envelope for the whole length of the digital audio signal and quantizing the RMS audio energy envelope into consecutive segments of 5 predefined audio energy levels using k-means, Eₛ=1 being the lowest segment energy level and Eₛ=5 being the highest segment energy level;

identifying the at least one representative frame by advancing along the RMS audio energy envelope and finding a segment that first satisfies a criterion of the following:

a. If a segment of Eₛ=5 is longer than any of the other segments of the same of lower energy level and a length of the segment of Eₛ=5 is L>Lₛ, select a first frame of the segment of Eₛ=5 as the at least one representative frame;
b. If the segment of Eₛ=5 is longer than 27.5% of the duration of the digital audio signal and the length of the segment of Eₛ=5 is L>Lₛ, select the first frame of the segment of Eₛ=5 as the at least one representative frame;
c. If a segment of Eₛ=4 exists and a length of the segment of Eₛ=4 is L>Lₛ, select a first frame of the segment of Eₛ=4 as the at least one representative frame;
d. If a segment of Eₛ=5 is longer than 15.0% of the duration of the digital audio signal and the length of the segment of Eₛ=5 is L>Lₛ, select the first frame of the segment of Eₛ=5 as the at least one representative frame;
e. If a segment of Eₛ=3 exists and a length of the segment of Eₛ=3 is L>Lₛ, select a first frame of the segment of Eₛ=5 as the at least one representative frame;

or, if a segment that first satisfies the criterion is not identified, selecting a first frame of the digital audio signal as the at least one representative frame; and

determining at least one representative segment of the digital audio signal with a predefined segment duration Lₛ, the starting point of the at least one representative segment being a representative frame.

By calculating an audio feature value (e.g. the average audio energy magnitude or the amount of shift in timbre) for each frame of the digital audio signal with a numerical value equal to or higher than zero it becomes possible to identify any frame that might indicate the starting point of a representative segment by locating at least one maximum value of the selected audio feature. The inventors arrived at the insight that the average audio energy magnitude or the amount of shift in timbre is a feature of a musical composition that allows the technical means such as a computer to effectively and accurately determine the representative part of a musical composition. This combination of musicology and digital signal processing enables obtaining musicologically objective and accurate results in a short time, which is particularly relevant for processing large catalogues of musical compositions with frequent additions. In contrast to e.g. searching for repetitive parts of the digital audio signal which can often result in locating non-representative instrumental sections (especially when analyzing strongly repetitive music, e.g. electronic dance music) this method locates more memorable, characteristic or “interesting” segments, which alone or in combination can represent the musical composition much better as a whole, by implementing the method according to the first aspect on a computer-based system. Thus, the manual process of a trained person listening to the musical composition and determining the most representative segment or segments can be replaced by the method according to the first aspect implemented on a computer-based system.

By using the RMS audio energy magnitude as the selected audio feature and identifying frames where this average audio energy is calculated to be the highest, the method can locate the starting points of the most “energetic” parts of a musical composition. These parts are often not the most frequently repeating sections of a composition and would therefore not be identified by other methods that analyze repetitiveness.

By calculating the temporal audio energy envelope for the whole musical composition and quantizing the resulting envelope into longer segments of constant energy levels it becomes easier to analyze the audio energy throughout the composition. The simplified energy envelope also reduces the time and computing power needed for locating the segments associated with the highest energy level, making it faster and more effective to locate at least one representative frame of the musical composition.

Advancing along the energy envelope and checking the fulfillment of the listed criteria in the specified order provides an easily applicable sequence of conditional steps that can be applied as a computer algorithm for locating the segment representing the most “powerful” portion of the musical composition. This segment usually has the longest duration in time with the highest corresponding ranking in power level, which results in a further reduction of time and computing power needed for locating at least one representative frame.

In a possible implementation form of the first aspect the method further comprises the steps of:

before quantizing, smoothing the RMS audio energy envelope by applying a Finite Impulse Response filter (FIR) using a filter length of L_{FIR}, and

after locating the representative frame, rewinding the result by L_{FIR}/2 seconds to adjust for the delay caused by applying the FIR.

In a possible implementation the filter length ranges from 1 s to 15 s, more preferably from 5 s to 10 s, more preferably the filter length is 8 s.

Applying this additional smoothing step, the time and computing power needed for quantizing the audio energy envelope for the whole musical composition can be further reduced. Even though this is usually a significant simplification step, the main characteristics of the original digital audio signal, such as the location of most significant changes in dynamics, are still represented in the resulting smoothed energy envelope.

According to a second aspect, there is provided a method of determining on a computer-based system at least one representative segment of a musical composition, the method comprising:

acquiring a digital audio signal representing the musical composition;

dividing the digital audio signal into a plurality of frames of equal frame duration L_{f};

calculating at least one audio feature value for each frame by calculating the Root Mean Squared (RMS) audio energy envelope for the whole length of said digital audio signal and quantizing said RMS audio energy envelope into consecutive segments of constant audio energy levels;

selecting the first frame of the at least one segment associated with the highest energy level as a representative frame; and

determining at least one representative segment of the digital audio signal with a predefined segment duration Lₛ, the starting point of the at least one representative segment being a representative frame.

In a possible implementation form of the second aspect the method further comprises the steps of:

before quantizing, smoothing the RMS audio energy envelope by applying a Finite Impulse Response filter (FIR) using a filter length of L_{FIR}, and

after locating the representative frame, rewinding the result by L_{FIR}/2 seconds to adjust for the delay caused by applying the FIR.

In a possible implementation the filter length ranges from 1 s to 15 s, more preferably from 5 s to 10 s, more preferably the filter length is 8 s.

According to a third aspect, there is provided a method of determining on a computer-based system at least one representative segment of a musical composition, the method comprising:

acquiring a digital audio signal representing the musical composition;

dividing the digital audio signal into a plurality of frames of equal frame duration L_{f};

calculating a Mel Frequency Cepstral Coefficient (MFCC) vector for each frame;

calculating the Euclidean distances between adjacent MFCC vectors;

identifying at least one representative frame corresponding to a maximum value of said calculated Euclidean distances between adjacent MFCC vectors; and

determining at least one representative segment of the digital audio signal with a predefined segment duration Lₛ, the starting point of the at least one representative segment being a representative frame.

By calculating the corresponding MFCC vectors for each frame and calculating the Euclidean distances between these vectors, the method can locate the parts of a musical composition where the biggest shift in timbre occurs between consecutive sections, as the location of these parts correspond to where the adjacent MFCC vectors are furthest from each other in the vector space. These parts are often not the most frequently repeating sections of a composition and would therefore not be identified by other methods that analyze repetitiveness.

In a possible implementation form of the third aspect calculating the MFCC vector for each frame comprises:

calculating the linear frequency spectrogram of the digital audio signal,

transforming the linear frequency spectrogram to a Mel spectrogram, and

calculating a plurality of coefficients for each MFCC vector by applying a cosine transformation on the Mel spectrogram.

In an implementation, a lowpass filter is applied to the digital audio signal before calculating the linear frequency spectrogram, preferably followed by downsampling the digital audio signal to a single channel (mono) signal using a sample rate of 22050 Hz. In a possible implementation, the number of Mel bands used for transforming the linear frequency spectrogram to a Mel spectrogram is ranging from 10 to 50, more preferably from 20 to 40, more preferably the number of used Mel bands is 34. In a possible implementation the number of MFCCs per MFCC vector is ranging from 10 to 50, more preferably from 20 to 40, more preferably the number of MFCCs per MFCC vector is 20.

Using the above specified number of Mel bands for transforming the linear frequency spectrogram to a Mel spectrogram, and then further reducing the number of coefficients by applying a cosine transformation, preferably to 20 coefficients, results in an efficient size of MFCC vector for each frame, which then allows for more efficient calculations when trying to identify a shift in timbre in the musical composition. By applying a lowpass filter and downsampling the digital audio signal, first from stereo to a mono signal if applicable, and then applying a sampling rate of 22050 Hz if that is lower than the sampling rate of the original digital audio signal, the resulting signal will still contain the relevant information for a sufficiently precise calculation of the linear frequency spectrogram but with significantly reduced amount of data per signal.

In a possible implementation form of the third aspect calculating the Euclidean distances between adjacent MFCC vectors comprises:

calculating, using two adjacent sliding frames with equal length applied step by step on the MFCC vector space along duration of the digital audio signal, a mean MFCC vector for each sliding frame at each step; and

calculating the Euclidean distances between said mean MFCC vectors at each step.

In a possible implementation, the length of the sliding frames ranges from 1 s to 15 s, more preferably from 5 s to 10 s, more preferably the length of each sliding frame is 7 s.

In a possible implementation, the step size ranges from 100 ms to 2 s, more preferably the step size is 1 s.

In a possible implementation, when calculating the mean MFCC vectors using the sliding frames, the first coefficient of each MFCC vector, which generally corresponds to the power of the audio signal, is ignored. This helps to further reduce the required computing power and memory for finding at least one representative frame while only sacrificing data that can safely be ignored for the process.

In a possible implementation form of the third aspect identifying the at least one representative frame comprises:

plotting the Euclidean distances to a Euclidean distance graph as a function of time,

scanning for peaks along the Euclidian distance graph using a sliding window, wherein if a middle value within the sliding window is identified as a local maximum, the frame corresponding to the middle value is selected as a representative frame, and

eliminating redundant representative frames that are within a buffer distance from a previously selected representative frame.

In a possible implementation the length of the sliding window is ranging from 1 s to 15 s, more preferably from 5 s to 10 s, more preferably the length of the sliding window is 7 s.

In a possible implementation the length of the buffer distance is ranging from 1 s to 20 s, more preferably from 5 s to 15 s, more preferably the length of the buffer distance is 10 s.

By calculating the Euclidian distances between adjacent mean MFCC vectors and plotting these distances as a time-based graph along the length of the digital audio signal, identifying a shift in timbre in the musical composition becomes easier, as these timbre shifts are directly correlated with the Euclidian distances between MFCC vectors. Using a sliding window provides an effective way for scanning the Euclidian distance graph for peaks and choosing the length for the sliding window within the indicated range means that when a local maximum value of Euclidian distance is found it can be directly identified as a possible location for a representative frame. The inventors further arrived at the insight that using a sliding window of 7 s is especially advantageous due to the coarse property of the resulting peak scanning, which leads to breaks or other short events in the musical composition being ignored, while still detecting changes in timbre (where an intro ends, or when a solo starts) effectively.

Eliminating redundant representative frames that are within a buffer distance of the indicated range from previously selected possible representative frames ensures that each resulting representative segment actually represents a different characteristic part of the musical composition, while still allowing for identifying multiple representative segments. This way, a more complete representation of the original musical composition can be achieved, that takes into account different characteristic parts of the composition regardless of their repetitiveness or perceived energy.

According to a fourth aspect, there is provided a method of determining on a computer-based system at least one representative segment of a musical composition, the method comprising:

acquiring a digital audio signal representing the musical composition,

dividing the digital audio signal into a plurality of frames of equal frame duration L_{f},

calculating at least one audio feature value for each frame by analyzing the digital audio signal, the audio feature being a numerical representation of a musical characteristic of the digital audio signal, with a numerical value equal to or higher than zero,

identifying at least one representative frame corresponding to a maximum value of the audio feature, and

determining at least one representative segment of the digital audio signal with a predefined segment duration Lₛ, the starting point of the at least one representative segment being a representative frame.

In a possible implementation form of the fourth aspect the audio feature value corresponds to the Root Mean Squared (RMS) audio energy magnitude.

In a possible implementation form of the fourth aspect identifying the at least one representative frame comprises the steps of:

calculating the Root Mean Squared (RMS) audio energy envelope for the whole length of the digital audio signal,

quantizing the RMS audio energy envelope into consecutive segments of constant audio energy levels, and

selecting the first frame of the at least one segment associated with the highest energy level.

In a possible implementation form of the fourth aspect the method further comprises the steps of:

before quantizing, smoothing the RMS audio energy envelope by applying a Finite Impulse Response filter (FIR) using a filter length of L_{FIR}, and

after locating the representative frame, rewinding the result by L_{FIR}/2 seconds to adjust for the delay caused by applying the FIR.

In a possible implementation the filter length ranges from 1 s to 15 s, more preferably from 5 s to 10 s, more preferably the filter length is 8 s.

In a possible implementation form of the fourth aspect the RMS audio energy envelope is quantized to 5 predefined levels using k-means, Eₛ=1 being the lowest segment energy level and Eₛ=5 being the highest segment energy level, wherein the method further comprises:

after quantizing the RMS audio energy envelope, identifying at least one representative frame by advancing along the RMS audio energy envelope and finding a segment that first satisfies a criterion of the following:

a. If a segment of Eₛ=5 is longer than any of the other segments of the same of lower energy level and its length is L>Lₛ, select its first frame as representative frame;

b. If a segment of Eₛ=5 is longer than 27.5% of the duration of the digital audio signal and its length is L>Lₛ, select its first frame as representative frame;

c. If a segment of Eₛ=4 exists and its length is L>Lₛ, select its first frame as representative frame;

d. If a segment of Eₛ=5 is longer than 15.0% of the duration of the digital audio signal and its length is L>Lₛ, select its first frame as representative frame;

e. If a segment of Eₛ=3 exists and its length is L>Lₛ, select its first frame as representative frame;

or, in case no such segment exists, selecting the first frame of the digital audio signal as representative frame.

According to a fifth aspect, there is provided a method of determining on a computer-based system representative segments of a musical composition, the method comprising:

acquiring a digital audio signal representing a musical composition,

dividing the digital audio signal into a plurality of frames of equal frame duration,

calculating at least one master audio feature value and at least one secondary audio feature value for each frame by analyzing the digital audio signal, said audio features being a numerical representation of a musical characteristic of said digital audio signal with a numerical value equal to or higher than zero,

identifying a master frame corresponding to a representative frame according to any possible implementation form of any of the first, second, or fourth aspects,

identifying at least one secondary frame corresponding to a representative frame according to any possible implementation form of the third aspect,

determining a master segment of the digital audio signal with a predefined master segment duration, the starting point of the master segment being a master frame, and

determining at least one secondary segment of the digital audio signal with a predefined secondary segment duration, the starting point of each secondary segment being a secondary frame.

Determining a master segment as well as at least one secondary segment of the digital audio signal allows for a more complex and more complete representation of the original musical composition, especially because the different methods used for locating the master and secondary segments use different audio features (the RMS audio energy magnitude or the MFCC vectors derived from the audio signal) as a basis. The resulting master and secondary segments can then be used for further analysis either separately, or in an arbitrary or temporally ordered combination.

In a possible implementation the frame duration is ranging from 100 ms to 10 s, more preferably from 500 ms to 5 s, more preferably the frame duration is 1 s. Selecting a frame duration from within these ranges, preferably taking into account the total duration of the digital audio signal, ensures that the data used for audio analysis is sufficiently detailed while also compact in data size in order to save computer memory and allow for efficient processing.

In a possible implementation the predefined segment duration, the predefined master segment duration, and the predefined secondary segment duration each range from 1 s to 60 s, more preferably from 5 s to 30 s, more preferably at least one of the predefined segment durations equals 15 s. Selecting a segment duration from within these ranges, preferably taking into account the total duration of the digital audio signal, ensures that the resulting data file is compact in size in order to save computer storage, while in the same time contains sufficient amount of audio information for further analysis or when used for playback as a preview of the full musical composition.

In a possible implementation, the method further comprises using any one of a representative segment, a master segment, or a secondary segment as a preview segment associated with the musical composition to be stored on a computer-based system and retrieved upon request for playback.

In a possible implementation, the method further comprises

selecting, by a user of the computer-based system, a musical composition;

retrieving a preview segment associated with the musical composition for playback, said preview segment being any one of a representative segment, a master segment, or a secondary segment; and

performing an action on the selected musical composition, the action comprising at least one of purchasing the selected musical composition, playback of the selected musical composition, and adding the selected musical composition to a playlist.

Using a segment determined using any of the above methods as an audio preview (by an online music provider for example) ensures that when the user requests a preview a sufficiently representative part of the musical composition is played back, not simply the first 15 or 30 seconds, or a repetitive but uninteresting part. This allows for the user to make a more informed decision of e.g. purchasing the selected composition.

In a possible implementation, the method further comprises using any one of a representative segment, a master segment, and at least one secondary segment as a data efficient representative summary of the musical composition.

In a possible implementation, the representative summary comprises at least one audio feature value calculated for each frame of the corresponding representative segment, master segment, or secondary segment, by analyzing the digital audio signal. In a possible implementation, the representative summary comprises an audio feature vector calculated for each frame.

In a possible implementation, the representative summary comprises an MFCC vector calculated for each frame, wherein the MFCC vectors preferably comprise a number of MFCCs ranging from 10 to 50, more preferably from 20 to 40, more preferably the number of MFCCs per MFCC vector is 34.

In a possible implementation, the representative summary comprises a Mel-spectrogram calculated for each frame, wherein preferably the number of Mel bands used for transforming the linear frequency spectrogram to a Mel spectrogram is ranging from 10 to 50, more preferably from 20 to 40, more preferably the number of used Mel bands is 34.

In a possible implementation, at least two different segments are used in combination to represent the musical composition. In a possible implementation, one master segment and at least one secondary segment is used in combination to represent the musical composition. In a possible implementation, one master segment and at least two secondary segments are used in combination to represent the musical composition. In a possible implementation, one master segment and at least five secondary segments are used in combination to represent the musical composition. In a possible implementation, the different segments are used in an arbitrary combination to represent the musical composition. In a possible implementation, the different segments are used in a temporally ordered combination to represent the musical composition.

In a possible implementation the method further comprises using the representative summary for comparing different musical compositions using a computer-based system in order to determine similarities between said musical compositions.

Using representative segments determined using any of the above methods as a representative summary of the musical composition when comparing different musical compositions increases the precision of the results and helps finding the compositions that are more similar to each other even if e.g. the analyzed compositions are repetitive in nature. Combining several segments, preferably a master segment and a plurality of secondary segments, preferably in a temporally ordered combination, not only allows for a more complex and more complete representation of the original musical composition, but also ensures further increased precision when comparing different musical compositions, especially if the analyzed compositions have a complex structure with dynamically or instrumentally different, and/or repetitive structural segments.

According to a sixth aspect, there is provided a computer-based system for determining at least one representative segment of a musical composition, the system comprising:

a machine-readable storage medium configured to store a program product and a digital audio signal representing a musical composition, and

at least one processor configured to execute program product and perform the the steps of any one of the possible implementation forms of the first, second, third, fourth or fifth aspects.

According to a seventh aspect, there is provided a machine-readable storage medium encoded thereon with a computer program product operable to cause a processor to perform operations according to the methods of any one of the possible implementation forms of the first, second, third, fourth or fifth aspects.

These and other aspects will be apparent from and the embodiment(s) described below.

### BRIEF DESCRIPTION OF THE DRAWINGS

In the following detailed portion of the present disclosure, the aspects, embodiments and implementations will be explained in more detail with reference to the example embodiments shown in the drawings, in which:

FIG. 1 is a flow diagram of a method in accordance with a possible implementation form of the first and/or the second aspect;

FIG. 2 is a flow diagram of a method in accordance with a possible implementation form of the first and/or the second aspect;

FIG. 3 illustrates on an exemplary line graph the steps of identifying a representative frame and determining a representative segment in accordance with a possible implementation form of the first aspect;

FIG. 4 is a flow diagram of a method in accordance with a possible implementation form of the third aspect;

FIG. 5A is a flow diagram illustrating the steps of calculating the MFCC vector using a method in accordance with a possible implementation form of the third aspect;

FIG. 5B is a flow diagram illustrating the steps of calculating the Euclidean distances between adjacent MFCC vectors using a method in accordance with a possible implementation form of the third aspect;

FIG. 6 illustrates on an exemplary bar graph the steps of identifying a representative frame in accordance with a possible implementation form of the third aspect;

FIG. 7 is a flow diagram of a method in accordance with a possible implementation form of the fifth aspect;

FIG. 8 illustrates on an exemplary plot of a digital audio signal the location of master and secondary segments determined by a method in accordance with a possible implementation form of the fifth aspect;

FIG. 9 is a block diagram of a computer-based system in accordance with a possible implementation form of the sixth aspect;

FIG. 10 is a block diagram of the client-server communication scheme of a computer-based system in accordance with a possible implementation form of the sixth aspect;

FIG. 11 is a flow diagram illustrating a possible implementation form of the fifth aspect of using a representative segment, a master segment, or a secondary segment as a preview segment for audio playback;

FIG. 12 is a flow diagram illustrating a possible implementation form of the fifth aspect of using a representative segment, a master segment, or a secondary segment for comparing different musical compositions.

### DETAILED DESCRIPTION

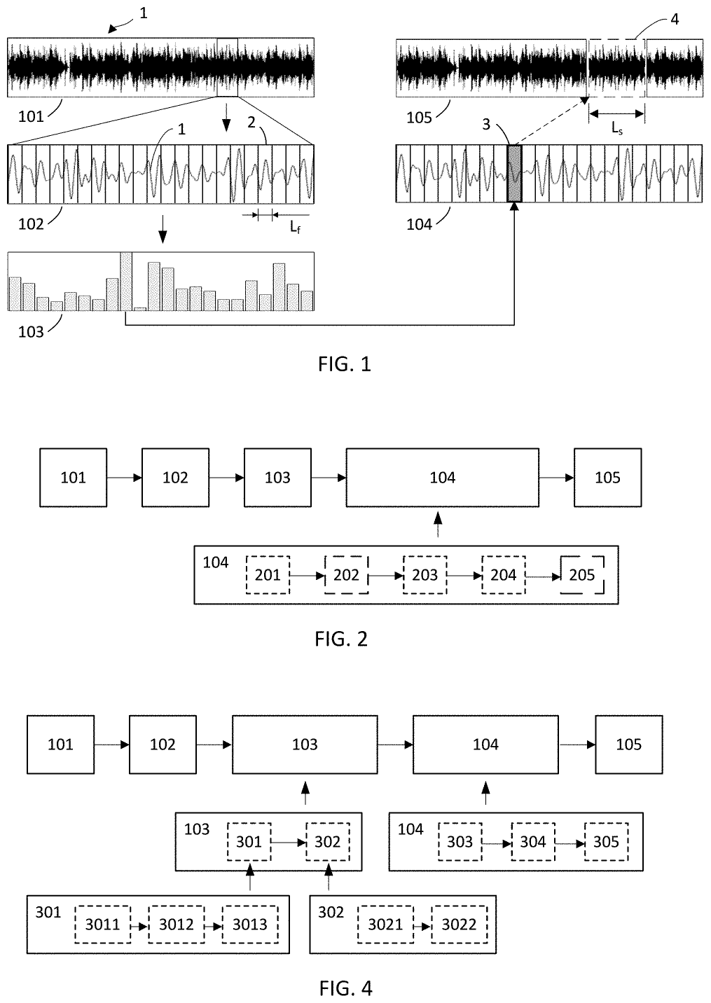

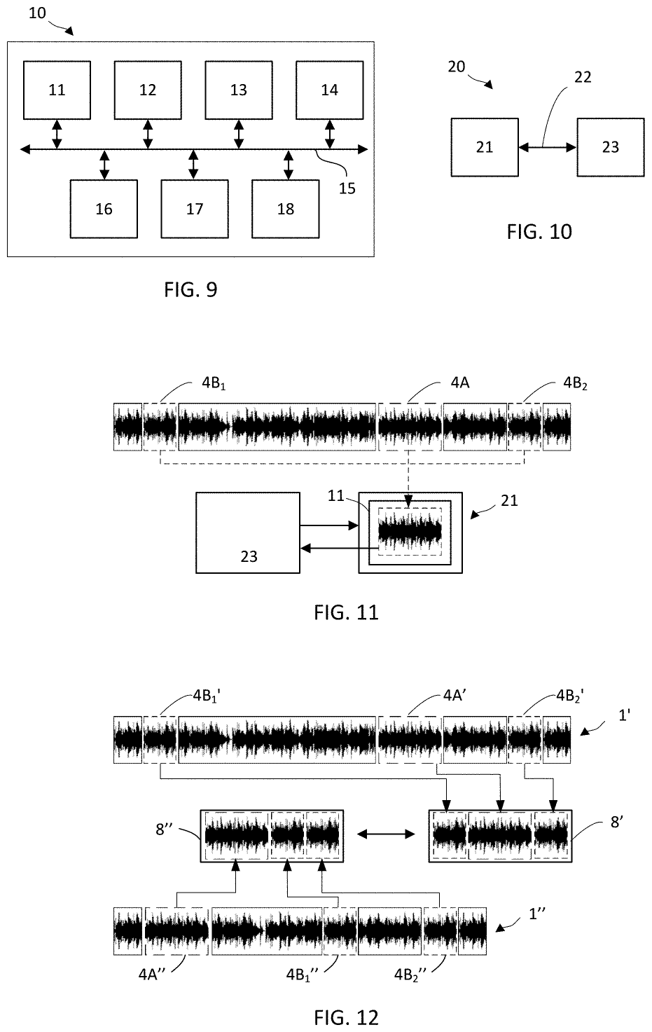

FIG. 1 shows a flow diagram of a method for determining a representative segment of a musical composition in accordance with the present disclosure, using a computer or computer-based system such as for example the system shown on FIG. 9 or FIG. 10.

In the first step 101 there is provided a digital audio signal 1 representing the musical composition.

Musical composition refers to any piece of music, either a song or an instrumental music piece, created (composed) by either a human or a machine.

Digital audio signal refers to any sound (e.g. music or speech) that has been recorded as or converted into digital form, where the sound wave (a continuous signal) is encoded as numerical samples in continuous sequence (a discrete-time signal). The average number of samples obtained in one second is called the sampling frequency (or sampling rate). An exemplary encoding format for digital audio signals generally referred to as “CD audio quality” uses a sampling rate of 44.1 thousand samples per second, however it should be understood that any suitable sampling rate can be used for acquiring the digital audio signals in step 101.

The digital audio signal 1 is preferably generated using Pulse-code modulation (PCM) which is a method frequently used to digitally represent sampled analog signals. In a PCM stream, the amplitude of the analog signal is sampled regularly at uniform intervals, and each sample is quantized to the nearest value within a range of digital steps.

The digital audio signal can be recorded to and stored in a file on a computer-based system where it can be further edited, modified, or copied. When a user wishes to listen to the original musical composition on an audio output device (e.g. headphones or loudspeakers) a digital-to-analog converter (DAC) can be used, as part of the computer-based system, to convert the digital audio signal back into an analog signal, through an audio power amplifier and to send it to a loudspeaker.

In a following step 102 the digital audio signal 1 is divided into a plurality of frames 2 of equal frame duration L_{f}. The frame duration L_{f} preferably ranges from 100 ms to 10 s, more preferably from 500 ms to 5 s. More preferably, the frame duration L_{f} is 1 s.

In a following step 103 at least one audio feature value is calculated for each frame 2 by analyzing the digital audio signal 1. The audio feature can be any numerical representation of a musical characteristic of the digital audio signal 1 (e.g. the average audio energy magnitude or the amount of shift in timbre) that has a numerical value equal to or higher than zero.

In a following step 104 at least one representative frame 3 is identified by searching for a maximum value of the selected audio feature along the length of the digital audio signal and locating the corresponding frame of the digital audio signal 1.

In a following step 105 at least one representative segment 4 of the digital audio signal 1 is determined by using a representative frame 3 as a starting point and applying a predefined segment duration Lₛ for each representative segment 4. The predefined segment duration Lₛ can be any duration that is shorter than the duration of the musical composition, and is determined by taking into account different factors such as copyright limitations, historically determined user preferences (when the segment is used as an audio preview) or the most efficient use of computing power (when the segment or combination of segments is used for similarity analysis). The inventors arrived at the insight that the segment duration is most optimal when it ranges from 1 s to 60 s, more preferably from 5 s to 30 s. More preferably, when the predefined segment duration is 15 s.

FIG. 2 shows a flow diagram illustrating a possible implementation of the method, wherein the step 104 of identifying said at least one representative frame 3 comprises several further sub-steps. In this implementation, steps and features that are the same or similar to corresponding steps and features previously described or shown herein are denoted by the same reference numeral as previously used for simplicity.

In the first sub-step 201 the Root Mean Squared (RMS) audio energy envelope 5 for the whole length of said digital audio signal is calculated. Calculating the RMS audio energy is a standard method used in digital signal processing, and the resulting values plotted as a temporal graph show the average value of the magnitude in audio energy of each of the plurality of frames 2 defined in step 102. Connecting these individual values with a liner iteration results in the RMS audio energy envelope 5 of the digital audio signal 1.

In a following, optional sub-step 202 the audio energy envelope 5 is smoothed by applying a Finite Impulse Response filter (FIR) using a filter length L_{FIR} ranging from 1 s to 15 s, more preferably from 5 s to 10 s, wherein most preferably the filter length is 8 s. Smoothing with such a filter length ensures that the time and computing power needed for quantizing the audio energy envelope 5 in a later step can be reduced, while in the same time the main characteristics of the original digital audio signal 1, such as the location of most significant changes in dynamics, are still represented in the resulting smoothed energy envelope 5.

In a following sub-step 203 the audio energy envelope 5 is quantized into consecutive segments of constant audio energy levels.

In a following sub-step 204 the first frame of at least one segment associated with the highest energy level is selected as a candidate for a representative frame 3.

In a following, optional sub-step 205, in case the energy envelope 5 was smoothed in sub-step 202, the location of the candidate frame is “rewinded” by L_{FIR}/2 seconds to adjust for the delay caused by applying the FIR, and the resulting frame is selected as representative frame 3.

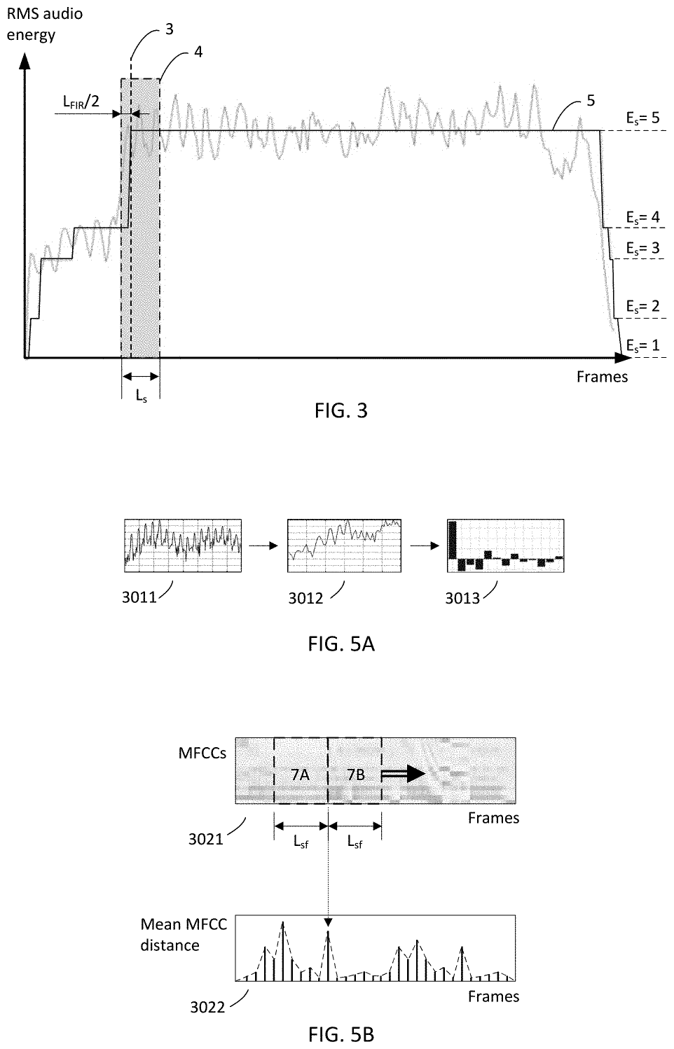

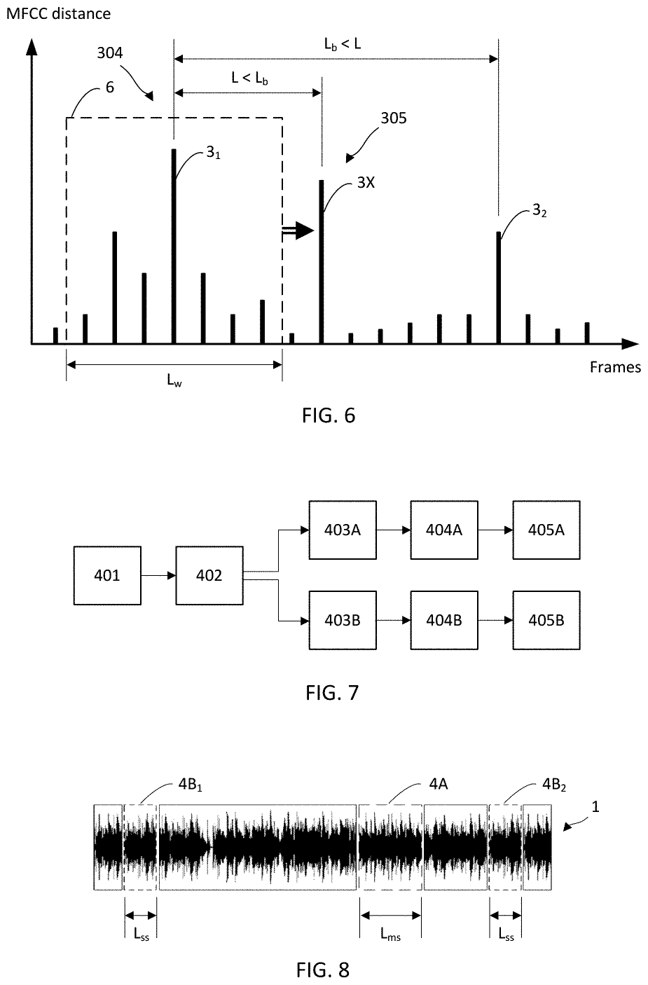

FIG. 3 shows an exemplary line graph which illustrates the steps of identifying a representative frame 3 and determining a representative segment 4 according to a possible implementation of the method. In this implementation, steps and features that are the same or similar to corresponding steps and features previously described or shown herein are denoted by the same reference numeral as previously used for simplicity. The audio energy envelope 5 here is smoothed applying a FIR and quantized to five predefined levels using k-means, Eₛ=1 being the lowest segment energy level and Eₛ=5 being the highest segment energy level. The candidate for representative frame 3 is identified by advancing along the energy envelope 5 and finding the segment that first satisfies a criterion of the following:

a. If a segment of Eₛ=5 is longer than any of the other segments of the same of lower energy level and its length is L>Lₛ, select its first frame as representative frame 3;
b. If a segment of Eₛ=5 is longer than 27.5% of the duration of the digital audio signal 1 and its length is L>Lₛ, select its first frame as representative frame 3;
c. If a segment of Eₛ=4 exists and its length is L>Lₛ, select its first frame as representative frame 3;
d. If a segment of Eₛ=5 is longer than 15.0% of the duration of the digital audio signal 1 and its length is L>Lₛ, select its first frame as representative frame 3;
e. If a segment of Eₛ=3 exists and its length is L>Lₛ, select its first frame as representative frame 3;

In case no such segment exists that satisfies any of the above criteria, the first frame of the digital audio signal 1 is selected as representative frame 3.

The resulting location for the representative frame 3 is then rewinded by L_{FIR}/2 seconds to adjust for the delay caused by applying the FIR. In a preferred implementation the selected filter length L_{FIR} is 8 s, so the starting frame of the representative segment 4 is determined by rewinding 4 seconds (L_{FIR}/2) from the location of the candidate representative frame 3.

FIG. 4 shows a flow diagram illustrating a possible implementation of the method, wherein steps 103 and 104 both can comprise several further sub-steps. Furthermore, sub-steps 301 and 302 can further comprise several sub-sub-steps. In this implementation, steps and features that are the same or similar to corresponding steps and features previously described or shown herein are denoted by the same reference numeral as previously used for simplicity.

In the first sub-step 301 of the step of calculating the audio feature value 103 a Mel Frequency Cepstral Coefficient (MFCC) vector is calculated for each frame. Mel Frequency Cepstral Coefficients (MFCCs) are used in digital signal processing as a compact representation of the spectral envelope of a digital audio signal, and provide a good description of the timbre of a digital audio signal. This sub-step 301 of calculating the MFCC vectors can also comprise further sub-sub-steps, as illustrated by FIG. 5A.

In a following sub-step 302 the Euclidean distances between adjacent MFCC vectors are calculated. This sub-step 302 of calculating the Euclidean distances between adjacent MFCC vectors can also comprise further sub-sub-steps, as illustrated by FIG. 5B.

In a following sub-step 303 of the step of identifying a representative frame 104 the above calculated Euclidean distances are plotted to a Euclidean distance graph as a function of time. Plotting these distances as a time-based graph along the length of the digital audio signal makes it easier to identify a shift in timbre in the musical composition, as these timbre shifts are directly correlated with the Euclidian distances between MFCC vectors.

In a following sub-step 304 the Euclidean distance graph is scanned for peaks using a sliding window 6. In a possible implementation the length of this sliding window is ranging from 1 s to 15 s, more preferably from 5 s to 10 s, more preferably the length of the sliding window is 7 s. During this step, if a middle value within the sliding window 6 is identified as a local maximum, the frame corresponding to said middle value is selected as a representative frame 3, as shown on FIG. 6.

In a following sub-step 305 redundant representative frames 3X that are within a buffer distance L_{b} from a previously selected representative frame 3 are eliminated, as also illustrated on FIG. 6. In a possible implementation the length of this buffer distance is ranging from 1 s to 20 s, more preferably from 5 s to 15 s, more preferably the length of the buffer distance is 10 s.

FIG. 5A illustrates the sub-sub-steps of the sub-step 301 of calculating the MFCC vector according to a possible implementation of the method.

In a first sub-sub-step 3011 the linear frequency spectrogram of the digital audio signal is calculated. In an implementation, a lowpass filter is applied to the digital audio signal before calculating the linear frequency spectrogram, preferably followed by downsampling the digital audio signal to a single channel (mono) signal using a sample rate of 22050 Hz.

In a following sub-sub-step 3012 the linear frequency spectrogram is transformed to a Mel spectrogram using a number of Mel bands ranging from 10 to 50, more preferably from 20 to 40, more preferably the number of used Mel bands is 34. This step accounts for the non-linear frequency perception of the human auditory system while reducing the number of spectral values to a fewer number of Mel bands. Further reduction of the number of bands can be achieved by applying a non-linear companding function, such that higher Mel-bands are mapped into single bands under the assumption that most of the rhythm information in the music signal is located in lower frequency regions. This step shares the Mel filterbank used in the MFCC computation.

In a following sub-sub-step 3013 a plurality of coefficients is calculated for each MFCC vector by applying a cosine transformation on the Mel spectrogram. The number of MFCCs per MFCC vector is ranging from 10 to 50, more preferably from 20 to 40, more preferably the number of MFCCs per MFCC vector is 20.

FIG. 5B illustrates the sub-sub-steps of the sub-step 302 of calculating the Euclidean distances between adjacent MFCC vectors according to a possible implementation of the method.

In the first sub-sub-step 3021 two adjacent sliding frames 7A, 7B with equal length Lₛf are applied step by step on the MFCC vector space along the duration of the digital audio signal 1. Using a step size Lₛₜ, a mean MFCC vector is calculated for each sliding frame 7A, 7B at each step. In a possible implementation the step size ranges from 100 ms to 2 s, more preferably the step size is 1 s. In a possible implementation, when calculating the mean MFCC vectors using the sliding frames, the first coefficient of each MFCC vector is ignored. For example, if the number of coefficients of the MFCC vectors after applying the cosine transformation is 20, only 19 coefficients are used for calculating the mean MFCC vectors.

In a following sub-sub-step 3022 the Euclidean distances between said mean MFCC vectors are calculated at each step along the duration of the digital audio signal 1, and these Euclidean distances are used for plotting the Euclidean distance graph and subsequently for peak scanning along the graph.

In a possible implementation the length Lₛf of the sliding frames 7A, 7B is ranging from 1 s to 15 s, more preferably from 5 s to 10 s, and more preferably the length of each sliding frame is 7 s.

FIG. 6 illustrates on an exemplary bar graph the steps of identifying a representative frame according to a possible implementation of the method as described above. As shown therein, the sliding window 6 advances along the Euclidean distance graph and finds a candidate for a representative frame by identifying a local maximum Euclidean distance value as the middle value within the sliding window 6. The location is saved as the first representative frame 3₁ and the sliding window 6 further advances along the graph locating a further candidate representative frame. The distance between the first representative frame 3₁ and the new candidate representative frame is then checked and because it is shorter than the predetermined buffer distance L_{b}, the candidate frame is identified as redundant representative frame 3X and is eliminated. The same process is then repeated, and a new candidate frame is located and subsequently identified as a second representative frame 3₂ after checking that its distance from the first representative frame 3₁ is larger than the predetermined buffer distance L_{b}. The location of the second representative frame 3₂ is then also saved.

FIG. 7 shows a flow diagram according to a possible implementation of the method, wherein the above described two methods of finding a representative frame 3 are combined to locate a master frame 3A and at least one secondary frame 3B. In this implementation, steps and features that are the same or similar to corresponding steps and features previously described or shown herein are denoted by the same reference numeral as previously used for simplicity.

In the first step 401 there is provided a digital audio signal 1 representing the musical composition.

In a following step 402 the digital audio signal 1 is divided into a plurality of frames 2 of equal frame duration L_{f}. The preferred ranges and values for frame duration are the same as described above in connection with the previous possible implementations of the method.

In the following steps a master audio feature value 403A and at least one secondary audio feature value 403B is calculated for each frame 2 by analyzing the digital audio signal 1. The master audio feature is a numerical representation of the Root Mean Squared (RMS) audio energy magnitude, as described above in connection with the previous possible implementations of the method. The secondary audio feature is a numerical representation of the shift in timbre in the musical composition, preferably based on the corresponding Euclidean distances between MFCC vectors calculated for each frame, as described above in connection with the previous possible implementations of the method.

In the following steps a master frame 3A is identified 404A by using the RMS audio energy magnitude derived from the digital audio signal 1 as the selected audio feature and locating a representative frame in accordance with any respective possible implementation of the method described above where the RMS audio energy magnitude is used as audio feature; and at least one secondary frame 3B is also identified 404B by using the Euclidean distances between respective MFCC vectors derived from the digital audio signal 1 as the selected audio feature and locating the at least one representative frame in accordance with any respective possible implementation of the method described above where the Euclidean distances between respective MFCC vectors are used as audio feature.

In the following steps a master segment 4A of the digital audio signal 1 is determined 405A by using a master frame 3A as a starting point and applying a predefined master segment duration Lₘₛ; and at least one secondary segment 4B of the digital audio signal 1 is determined 405B by using a respective secondary frame 3B as a starting point and applying a predefined secondary segment duration Lₛₛ.

The steps 403A-404A-405A of determining the master segment 4A and the steps 403B-404B-405B of determining the at least one secondary segment 4B can be executed as parallel processes, as illustrated in FIG. 7, but also in any preferred sequence one after the other.

FIG. 8 illustrates an exemplary plot of a digital audio signal and the location of a master segment 4A and two secondary segments 4B₁ and 4B₂ in accordance with any respective possible implementation of the method described above where both a master segment 4A with a predefined master segment duration Lₘₛ and at least one secondary segment 4B with a predefined secondary segment duration Lₛₛ is determined. In this exemplary implementation the two secondary segments 4B₁ and 4B₂ are located towards the beginning and the end of the digital audio signal 1 respectively, while the master segment 4A is located in between. However, as can also be seen in FIG. 12, the location of the master segment 4A and secondary segments 4B in relation to the whole duration of the digital audio signal 1 can vary, or in some cases the segments 4A and 4B can also overlap each other.

FIG. 9 shows a schematic view of an illustrative computer-based system 10 in accordance with the present disclosure.

The computer-based system 10 can be the same or similar to a client device 104 shown below on FIG. 10, or can be a system not operative to communicate with a server. The computer-based system 10 can include a storage medium 11, a processor 12, a memory 13, a communications circuitry 14, a bus 15, an input interface 16, an audio output 17, and a display 18. The computer-based system 10 can include other components not shown in FIG. 9, such as a power supply for providing power to the components of the computer-based system. Also, while only one of each component is illustrated, the computer-based system 10 can include more than one of some or all of the components.

A storage medium 11 stores information and instructions to be executed by the processor 12. The storage medium 11 can be any suitable type of storage medium offering permanent or semi-permanent memory. For example, the storage medium 11 can include one or more storage mediums, including for example, a hard drive, Flash, or other EPROM or EEPROM. As described in detail above, the storage medium 11 can be configured to store digital audio signals 1 representing musical compositions, and to store representative segments 4 of musical compositions determined using computer-based system 10, in accordance with the present disclosure.

A processor 12 controls the operation and various functions of system 10. As described in detail above, the processor 12 can control the components of the computer-based system 10 to determine at least one representative segment 4 of a musical composition, in accordance with the present disclosure. The processor 12 can include any components, circuitry, or logic operative to drive the functionality of the computer-based system 10. For example, the processor 12 can include one or more processors acting under the control of an application.

In some embodiments, the application can be stored in a memory 13. The memory 13 can include cache memory, Flash memory, read only memory (ROM), random access memory (RAM), or any other suitable type of memory. In some embodiments, the memory 13 can be dedicated specifically to storing firmware for a processor 12. For example, the memory 13 can store firmware for device applications (e.g. operating system, scan preview functionality, user interface functions, and other processor functions).

A bus 15 may provide a data transfer path for transferring data to, from, or between a storage medium 11, a processor 12, a memory 13, a communications circuitry 14, and some or all of the other components of the computer-based system 10.

A communications circuitry 14 enables the computer-based system 10 to communicate with other devices, such as a server (e.g., server 21 of FIG. 10). For example, communications circuitry 14 can include Wi-Fi enabling circuitry that permits wireless communication according to one of the 802.11 standards or a private network. Other wired or wireless protocol standards, such as Bluetooth, can be used in addition or instead.

An input interface 16, audio output 17, and display 18 provides a user interface for a user to interact with the computer-based system 10.

The input interface 16 may enable a user to provide input and feedback to the computer-based system 10. The input interface 16 can take any of a variety of forms, such as one or more of a button, keypad, keyboard, mouse, dial, click wheel, touch screen, or accelerometer.

An audio output 17 provides an interface by which the computer-based system 10 can provide music and other audio elements to a user. The audio output 17 can include any type of speaker, such as computer speakers or headphones.

A display 18 can present visual media (e.g., graphics such as album cover, text, and video) to the user. A display 18 can include, for example, a liquid crystal display (LCD), a touchscreen display, or any other type of display.

FIG. 10 shows a schematic view of an illustrative client-server data system 20 configured in accordance with the present disclosure. The data system 20 can include a server 21 and a client device 23. In some embodiments, the data system 20 includes multiple servers 21, multiple client devices 23, or both multiple servers 21 and multiple client devices 23. To prevent overcomplicating the drawing, only one server 21 and one client device 23 are illustrated.

The server 21 may include any suitable types of servers that are configured to store and provide data to a client device 23 (e.g., file server, database server, web server, or media server). The server 21 can store media and other data (e.g., digital audio signals of musical compositions, or metadata associated with musical compositions), and the server 21 can receive data download requests from the client device 23.

The server 21 can communicate with the client device 23 over the communications link 22. The communications link 22 can include any suitable wired or wireless communications link, or combinations thereof, by which data may be exchanged between server 21 and client 23. For example, the communications link 22 can include a satellite link, a fiber-optic link, a cable link, an Internet link, or any other suitable wired or wireless link. The communications link 22 is in an embodiment configured to enable data transmission using any suitable communications protocol supported by the medium of communications link 22. Such communications protocols may include, for example, Wi-Fi (e.g., a 802.11 protocol), Ethernet, Bluetooth (registered trademark), radio frequency systems (e.g., 900 MHz, 2.4 GHz, and 5.6 GHz communication systems), infrared, TCP/IP (e.g., and the protocols used in each of the TCP/IP layers), HTTP, BitTorrent, FTP, RTP, RTSP, SSH, any other communications protocol, or any combination thereof.

The client device 23 can be the same or similar to the computer-based system 10 shown on FIG. 9, and includes in an embodiment any electronic device capable of playing audio to a user and may be operative to communicate with server 21. For example, the client device 23 includes in an embodiment a portable media player, a cellular telephone, pocket-sized personal computers, a personal digital assistant (PDA), a smartphone, a desktop computer, a laptop computer, and any other device capable of communicating via wires or wirelessly (with or without the aid of a wireless enabling accessory device).

FIG. 11 illustrates a possible implementation form of using a representative segment 4, a master segment 4A, or a secondary segment 4B, determined in accordance with any respective possible implementation of the method described above, as a preview segment for audio playback. The preview segment is selected from the above determined representative segment 4, master segment 4A, or secondary segment 4B according to certain preferences of the end user or a music service provider platform. The preview segment is stored on a storage medium 11 of a computer-based system 10, preferably on a publicly accessible server 21 and can be retrieved by a client device 23 upon request for playback. In a possible implementation, after successful authentication of the client device 23 the preview segment can either be streamed or downloaded as a complete data package to the client device 23.

FIG. 12 illustrates a possible implementation form of using a master segment 4A and two secondary segments 4B₁ and 4B₂ in combination, for comparing two digital audio signals of different musical compositions. Even though in this exemplary implementation only two musical compositions are compared, it should be understood that the method can also be used for comparing a larger plurality of musical compositions and determining a similarity ranking between those compositions.

In a first step, a first digital audio signal 1′ and a second digital audio signal 1″ are provided, each representing a different musical composition.

In a following step, a master segment 4A′ and two secondary segments 4B₁′ and 4B₂′ are determined from the first digital audio signal 1′, and a master segment 4A″ and two secondary segments 4B₁″ and 4B₂″ are determined from the second digital audio signal 1″, each in accordance with a respective possible implementation of the method described above. Even though in this exemplary implementation only one master segment and two secondary segments are determined for each digital audio signal, it should be understood that different numbers and combinations of master and secondary segments can also be used in other possible implementations of the method.

In a following step, a first representative summary 8′ is constructed for the first digital audio signal 1′ by combining the master segment 4A′ and the two secondary segments 4B₁′ and 4B₂′, and a second representative summary 8″ is constructed for the second digital audio signal 1′ by combining the master segment 4A″ and the two secondary segments 4B₁″ and 4B₂″. In this exemplary implementation, the master and secondary segments are used in a temporally ordered combination to represent each musical composition in their respective representative summaries. However, it should be understood that the master and secondary segments can also be used in an arbitrary combination.

Once both the first representative summary 8′ and the second representative summary 8″ are constructed they can be used as input in any known method or device designed for determining similarities between musical compositions. The result of such methods or devices are usually a similarity score or ranking between the compositions, which can be used for facilitating music information retrieval processes, such as generating music recommendations based on seed music items, or grouping music files together into playlists, either in a large online music catalogue stored on a streaming server, or on a local storage of a client device.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems.

The reference signs used in the claims shall not be construed as limiting the scope.

1-15. (canceled)

16. A method of determining on a computer-based system at least one representative segment of a musical composition, the method comprising:
acquiring a digital audio signal representing said musical composition;
dividing said digital audio signal into a plurality of frames of equal frame duration L_{f},
calculating at least one audio feature value for each frame by calculating the Root Mean Squared, RMS, audio energy envelope or the whole length of said digital audio signal and quantizing said RMS audio energy envelope into consecutive segments of constant audio energy levels;
selecting the first frame of the at least one segment associated with the highest energy level as a representative frame; and
determining at least one representative segment of the digital audio signal with a predefined segment duration Lₛ, the starting point of said at least one representative segment being a representative frame.

17. The method according to claim 16, the method further comprising:
before quantizing, smoothing the RMS audio energy envelope by applying a Finite Impulse Response filter, FIR, using a filter length of L_{FIR}; and
after identifying the representative frame, rewinding the result by L_{FIR}/2 seconds to adjust for the delay caused by applying the FIR;
wherein said filter length 1 s<L_{FIR}<15 s, more preferably 5 s<L_{FIR}<10 s, more preferably L_{FIR}=8 s.

18. The method according to claim 16, wherein the audio energy envelope is quantized to 5 predefined levels using k-means, Eₛ=1 being the lowest segment energy level and Eₛ=5 being the highest segment energy level, and wherein the method further comprises:
after quantizing the audio energy envelope, identifying said at least one representative frame by advancing along the energy envelope and finding the segment that first satisfies a criterion of the following:
a. If a segment of Eₛ=5 is longer than any of the other segments of the same of lower energy level and its length is L>Lₛ, select its first frame as representative frame;
b. If a segment of Eₛ=5 is longer than 27.5% of the duration of the audio signal and its length is L>Lₛ, select its first frame as representative frame;
c. If a segment of Eₛ=4 exists and its length is L>Lₛ, select its first frame as representative frame;
d. If a segment of Eₛ=5 is longer than 15.0% of the duration of the audio signal and its length is L>Lₛ, select its first frame as representative frame;
e. If a segment of Eₛ=3 exists and its length is L>Lₛ, select its first frame as representative frame;
or, in case no such segment exists, selecting the first frame of the audio signal as representative frame.

19. A method of determining on a computer-based system at least one representative segment of a musical composition, the method comprising:
acquiring a digital audio signal representing said musical composition,
dividing said digital audio signal into a plurality of frames of equal frame duration L_{f},
calculating at least one audio feature value for each frame by calculating a Mel Frequency Cepstral Coefficient, MFCC, vector for each frame and calculating the Euclidean distances between adjacent MFCC vectors;
identifying at least one representative frame corresponding to a maximum value of said calculated Euclidean distances between adjacent MFCC vectors; and
determining at least one representative segment of the digital audio signal with a predefined segment duration Lₛ, the starting point of said at least one representative segment being a representative frame.

20. The method according to claim 19, wherein calculating the Euclidean distances between adjacent MFCC vectors comprises:
calculating, using two adjacent sliding frames with equal length L_{sf} applied step by step on the MFCC vector space along duration of the digital audio signal, using a step size Lₛₜ, a mean MFCC vector for each sliding frame at each step; and
calculating the Euclidean distances between said mean MFCC vectors at each step; wherein
the length of said sliding frames is 1 s<L_{sf}<15 s, more preferably 5 s<L_{sf}<10 s, more preferably L_{sf}=7 s, and wherein
the step size is 100 ms<Lₛₜ<2 s, more preferably Lₛₜ=1 s.

21. The method according to claim 19, wherein identifying said at least one representative frame comprises:
plotting said Euclidean distances to a Euclidean distance graph as a function of time, scanning for peaks along the Euclidean distance graph using a sliding window with a length L_{w},
wherein if a middle value within the sliding window is identified as a local maximum, the frame corresponding to said middle value is selected as a representative frame, and
eliminating redundant representative frames that are within a buffer distance L_{b} from a previously selected representative frame, wherein
the length of said sliding window is 1 s<L_{w}<15 s, more preferably 5 s<L_{w}<10 s, more preferably L_{w}=7 s, and wherein
the length of said buffer distance is 1 s<L_{b}<20 s, more preferably 5 s<L_{b}<15 s, more preferably L_{b}=10 s.

22. A method of determining on a computer-based system representative segments of a musical composition, the method comprising:
acquiring a digital audio signal representing a musical composition,
dividing aid digital audio signal into a plurality of frames of equal frame duration L_{f},
calculating at least one master audio feature value and at least one secondary audio feature value for each frame by analyzing the digital audio signal, said master audio feature value and said at least one secondary audio feature value each being a numerical representation of a different musical characteristic of said digital audio signal with a numerical value equal to or higher than zero,
identifying a master frame corresponding to a representative master audio feature value, identifying at least one secondary frame corresponding to a representative secondary audio feature value,
determining a master segment of the digital audio signal with a predefined segment duration _{Lms}, the starting point of said master segment being a master frame, and
determining at least one secondary segment of the digital audio signal with a predefined segment duration _{Lss}, the starting point of each secondary segment being a secondary frame.

23. The method according to claim 22, wherein the master audio feature value corresponds to the Root Mean Squared, RMS, audio energy magnitude derived from the digital audio signal; and wherein identifying said master frame comprises:
calculating the RMS audio energy envelope for the whole length of said digital audio signal;
quantizing said RMS audio energy envelope into consecutive segments of constant audio energy levels; and
selecting the first frame of the at least one segment associated with the highest energy level as the master frame.

24. The method according to claim 23, wherein identifying said master frame further comprises:
before quantizing, smoothing the RMS audio energy envelope by applying a Finite Impulse Response filter, FIR, using a filter length of L_{FIR}; and
after identifying the master frame, rewinding the result by L_{FIR}/2 seconds to adjust for the delay caused by applying the FIR;
wherein said filter length 1 s<L_{FIR}<15 s, more preferably 5 s<L_{FIR}<10 s, more preferably L_{FIR}=8 s.

25. The method according to claim 23, wherein the audio energy envelope is quantized to 5 predefined levels using k-means, Eₛ=1 being the lowest segment energy level and Eₛ=5 being the highest segment energy level, and wherein identifying said master frame further comprises: after quantizing the audio energy envelope, advancing along the energy envelope and finding the segment that first satisfies a criterion of the following:
a. If a segment of Eₛ=5 is longer than any of the other segments of the same of lower energy level and its length is L>Lₘₛ, select its first frame as master frame;
b. If a segment of Eₛ=5 is longer than 27.5% of the duration of the audio signal and its length is L>Lₘₛ, select its first frame as master frame;
c. If a segment of Eₛ=4 exists and its length is L>Lₘₛ, select its first frame as master frame (3A);
d. If a segment of Eₛ=5 is longer than 15.0% of the duration of the audio signal and its length is L>Lₘₛ, select its first frame as master frame;
e. If a segment of Eₛ=3 exists and its length is L>Lₘₛ, select its first frame as master frame;
or, in case no such segment exists, selecting the first frame of the audio signal as master frame.

26. The method according to claim 22, wherein at least one secondary audio feature value is a numerical representation of the shift in timbre in the musical composition, based on the corresponding Euclidean distances between MFCC vectors calculated for each frame; and
wherein identifying at least one secondary frame comprises:
calculating an MFCC vector for each frame;
calculating the Euclidean distances between adjacent MFCC vectors; and
identifying at least one secondary frame corresponding to a maximum value of said calculated Euclidean distances between adjacent MFCC vectors.

27. The method according to claim 26, wherein calculating the Euclidean distances between adjacent MFCC vectors comprises:
calculating, using two adjacent sliding frames with equal length L_{sf} applied step by step on the MFCC vector space along duration of the digital audio signal, using a step size Lₛₜ, a mean MFCC vector for each sliding frame at each step; and
calculating the Euclidean distances between said mean MFCC vectors at each step; wherein
the length of said sliding frames is 1 s<L_{sf}<15 s, more preferably 5 s<L_{sf}<10 s, more preferably L_{sf}=7 s, and wherein
the step size is 100 ms<Lₛₜ<2 s, more preferably Lₛₜ=1 s.

28. The method according to claim 26, wherein identifying at least one secondary frame further comprises:
plotting said Euclidean distances to a Euclidean distance graph as a function of time,
scanning for peaks along the Euclidean distance graph using a sliding window with a length L_{w}, wherein if a middle value within the sliding window is identified as a local maximum, the frame corresponding to said middle value is selected as a representative frame, and
eliminating redundant representative frames that are within a buffer distance L_{b} from a previously selected representative frame, wherein
the length of said sliding window is 1 s<L_{w}<15 s, more preferably 5 s<L_{w}<10 s, more preferably L_{w}=7 s, and wherein
the length of said buffer distance is 1 s<L_{b}<20 s, more preferably 5 s<L_{b}<15 s, more preferably L_{b}=10 s.

29. A non-transitory computer-readable storage medium encoded thereon with a computer program product configured to cause a computer to implement the method of claim 16.

30. A non-transitory computer-readable storage medium encoded thereon with a computer program product configured to cause a computer to implement the method of claim 19.

31. A non-transitory computer-readable storage medium encoded thereon with a computer program product configured to cause a computer to implement the method of claim 22.
